(19) United States
(12) Patent Application Publication
(10) Pub. No.: US 2005/0206075 A1
(43) Pub. Date: Sep. 22, 2005

(54) Recording-material carrying device, photographic printer, ink-jet printer and electrophotographic printer

(75) Inventor: Atsushi Yago, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/065,090

(22) Filed: Feb. 25, 2005

(30) Foreign Application Priority Data
Feb. 27, 2004 (JP) 2004-055302

(51) Int. Cl. B65H 5/04; B65H 5/02; G03G 15/20; G03G 9/08

(52) U.S. Cl. 271/272; 430/117

(57) ABSTRACT

An inlet, first to third carrying roller pairs, and a high-speed discharge roller pair are disposed along a first passage of a passage changing section of a photographic printer. Fourth to sixth carrying roller pairs are disposed at a second passage of the passage changing section. First to sixth carrying guides are respectively disposed between the inlet and the first carrying roller pair and between the respective carrying roller pairs. The carrying guides are slantingly disposed relative to the first and second passages such that a downstream guide end of the carrying guide in a carrying direction is nearer to the passage than an upstream guide end thereof. Thus, a recording surface of a recording material is prevented from being damaged.

### BACKGROUND OF THE INVENTION

1. Field of the Invention

The present invention relates to a carrying device for curving and carrying a sheet-shaped recording material, and further relates to a photographic printer, an ink-jet printer and an electrophotographic printer comprising this carrying device.

2. Description of the Related Art

For example, in a photographic printer, various processes of exposing, developing, drying and so forth are performed in order while a photosensitive recording paper having a cut-sheet shape is carried in a sub-scanning direction perpendicular to a scanning direction. The photosensitive recording paper is nipped and carried by a plurality of carrying roller pairs disposed along a passage. Since the printer has restrictions concerning a size and so forth, the passage is curved at several portions in the printer. Thus, curved guides (carrying guides) are provided at the curved portion of the passage. The curved guide is disposed between the carrying roller pairs to guide the recording paper from the upstream carrying roller pair to the downstream carrying roller pair. The curved guide, namely the carrying guide, comprises a recording-surface guide for guiding a recording surface of the recording paper, and a rear-surface guide for guiding a rear surface thereof. The recording paper is carried along the passage formed by both of the surface guides.

The photosensitive recording paper sometimes warps due to drying conditions and variations of thickness of the recording paper such that the recording surface or the rear surface becomes convex. When the recording paper warps, it is impossible to normally carry the recording paper with the carrying roller pairs so that the recording paper is likely to be partially curled up and to be partially bent. Further, the recording surface is likely to be damaged. In view of this, a small free roller being freely rotatable in association with the carry of the recording paper is attached to the recording-surface guide disposed after a drying section. In virtue of this, the recording paper is adapted to be normally carried (see Japanese Patent Laid-Open Publication No. 2002-196466).

Such as described in the above-noted Publication No. 2002-196466, by attaching the free roller to the curved guide, it is possible to prevent the recording surface from being damaged due to the warp of the recording paper. However, when the recording paper is carried along the curved guide, the recording surface comes into contact with the recording-surface guide in a slide state. It is impossible to prevent the recording surface from being damaged due to the contact with the recording-surface guide. In particular, the recording surface is easily damaged just after drying the photosensitive recording paper because gelatin, which is a main ingredient of the recording paper, is still in a soft state. Since the gelatin expands during a developing/drying process, scratches caused on the recording surface before the drying process is hardly noticeable. However, scratches caused after the drying process remains as it is. Thus, quality of a photo print is likely to remarkably deteriorate.

In view of the above, the recording-surface guide is formed with a plurality of ribs, which are parallel in the sub-scanning direction, for the purpose of preventing the scratches by reducing a contact area of the recording surface and the recording-surface guide. In general, many of the carrying guides are made of SUS (stainless steel) material on the grounds that this material is easily processed and hardly rusts out, and the rib is usually formed by drawing processing. Hence, when the rib is heightened for the purpose of reducing the contact with the recoding paper, drawing wrinkles occur on the top of the rib so that the recording surface is likely to be damaged by contraries.

Meanwhile, an end portion of the recording-surface guide situated at a downstream side in a carrying direction is usually formed in a straight shape being parallel with a width direction of the recording paper. Thus, a gap is formed between the end portion of the downstream side and a carrying roller pair disposed near the end portion. When the recording paper is advanced to the carrying roller pair, there is a limitation to bring the recording paper close to the carrying roller pair. As a result, the recording surface of the recording paper is likely to come into contact with the end portion of the guide and is likely to be damaged when the recording paper is guided to the carrying roller pair of the downstream side. In order to prevent this, it is considered to buff the end portion of the guide, for example. However, there arises a problem in that the cost of manufacturing increases.

### SUMMARY OF THE INVENTION

In view of the foregoing, it is a primary object of the present invention to provide, at low cost, a recording-material carrying device in which a recording surface of the recording material carried along a curved passage is prevented from being damaged.

It is a second object of the present invention to provide, at low cost, a photographic printer, an ink-jet printer and an electrophotographic printer employing the carrying device of the present invention.

In order to achieve the above and other objects, the recording-material carrying device according to the present invention comprises a plurality of carrying roller pairs disposed along a curved passage of a recording material. The carrying roller pair includes a recording-surface side roller for coming into contact with a recording-surface side of the recording material, and a rear-surface side roller for coming into contact with a rear-surface side of the recording material. The recording-material carrying device further comprises a carrying guide disposed between the adjacent two carrying roller pairs to guide a recording surface of the recording material toward the downstream carrying roller pair in a carrying direction of the recording material. The carrying guide has a first guide end of a downstream side and a second guide end of an upstream side. The first guide end is situated at a closer position to the passage relative to a central axis of the recording-surface side roller. The second guide end is situated at a farther position from the passage relative to the central axis of the recording-surface side roller.

In a preferred embodiment, the carrying guide is curved in a V-shape such that a side thereof confronting the recording surface of the recording material is concave. It is preferable that a curved portion of the carrying guide curved in the V-shape is formed in an arc shape.

The recording-surface side roller is preferable to be a skewered-shape roller. In this case, at least the first guide end is formed in a comb-shape corresponding to the skewered-shape roller, and the carrying guide is disposed so as to insert the first guide end of the comb-shape into roller gaps of the skewered-shape roller. Moreover, it is preferable that a surface of the carrying guide confronting the recording surface of the recording material is formed with a plurality of ribs, which extend in parallel to the carrying direction of the recording material and are arranged in a width direction thereof. Further, it is preferable that a downstream end of the rib in the carrying direction extends close to the first guide end and is formed in an arc shape. Furthermore, it is preferable that a height of the rib is set within a range of 0.2 to 0.4 mm.

The photographic printer according to the present invention comprises an exposing device for performing image exposure on the recording material, a processing device for processing the exposed recording material, a drying device for drying the processed recording material, and the above-mentioned recording-material carrying device disposed at a downstream side of the drying device in the carrying direction of the recording material.

The ink-jet printer according to the present invention comprises an ink-jet head for recording an image by jetting an ink toward the recording material, and the above-mentioned recording-material carrying device disposed at a downstream side of the ink-jet head in the carrying direction of the recording material.

An electrophotographic printer according to the present invention comprises an image-transferring unit for transferring a toner image, which is formed in an electrophotographic manner, to the recording material, and the above-mentioned recording-material carrying device disposed at a downstream side of the image-transferring unit in the carrying direction of the recording material.

According to the present invention, when the recording material moves along the carrying guide, only an anterior end and a posterior end thereof come into contact with the carrying guide. As a result, it is possible to prevent the recoding surface of the recoding material from being damaged. In addition, it is unnecessary to buff a recording-surface side of the carrying guide so that production cost may be held down.

Since the carrying guide is curved in the V-shape, the recording surface of the recording material is similarly prevented from being damaged.

Since the curved portion of the carrying guide is formed in the arc shape, the anterior end and the posterior end of the recording material are prevented from being caught.

Since the first guide end of the comb-shape enters the roller gaps of the recording-surface side roller of the skewered-shape, the recording surface of the recording material is prevented from sliding on an edge of the first guide end.

Since the surface of the carrying guide confronting the recording surface of the recording material is formed with the ribs extending in the carrying direction of the recording material, and since the downstream end of the rib is formed in the arc shape, the recording surface of the recording material is similarly prevented from being damaged.

Since the height of the rib is within the range of 0.2 to 0.4 mm, draw wrinkles are prevented from occurring on the top of the rib.

The photographic printer, the ink-jet printer and the electrophotographic printer according to the present invention comprise the recording-material carrying device so that the recording surface of the recording material is similarly prevented from being damaged.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a schematic illustration showing a photographic printer using a carrying device according to the present invention;

FIG. 2A is a schematic illustration showing a passage changing section of the photographic printer;

FIGS. 2B, 2C and 2D are enlarged views partially enlarging the passage changing section;

FIG. 3 is a perspective view showing a downstream end portion of a carrying guide disposed in the passage changing section;

FIG. 4 is a section view showing a rib formed on the carrying guide;

FIGS. 5A, 5B and 5C are explanatory illustrations, wherein FIG. 5A shows a state in that an anterior end of a paper sheet is advanced from an upstream roller pair, FIG. 5B shows a state in that the anterior end of the paper sheet is guided to a downstream roller pair, and FIG. 5C shows a state in that the anterior end of the paper sheet is nipped by the downstream roller pair;

FIGS. 6A and 6B are explanatory illustrations, wherein FIG. 6A shows a state in that a posterior end of the paper sheet is advanced from the upstream roller pair, and FIG. 6B shows a state in that the posterior end of the paper sheet is guided to the downstream roller pair;

FIG. 7 is a schematic illustration of an ink-jet printer employing the carrying device according to the present invention; and

FIG. 8 is a schematic illustration of an electrophotographic printer employing the carrying device according to the present invention.

### DETAILED DESCRIPTION OF THE PREFERRED EMBODIMENT(S)

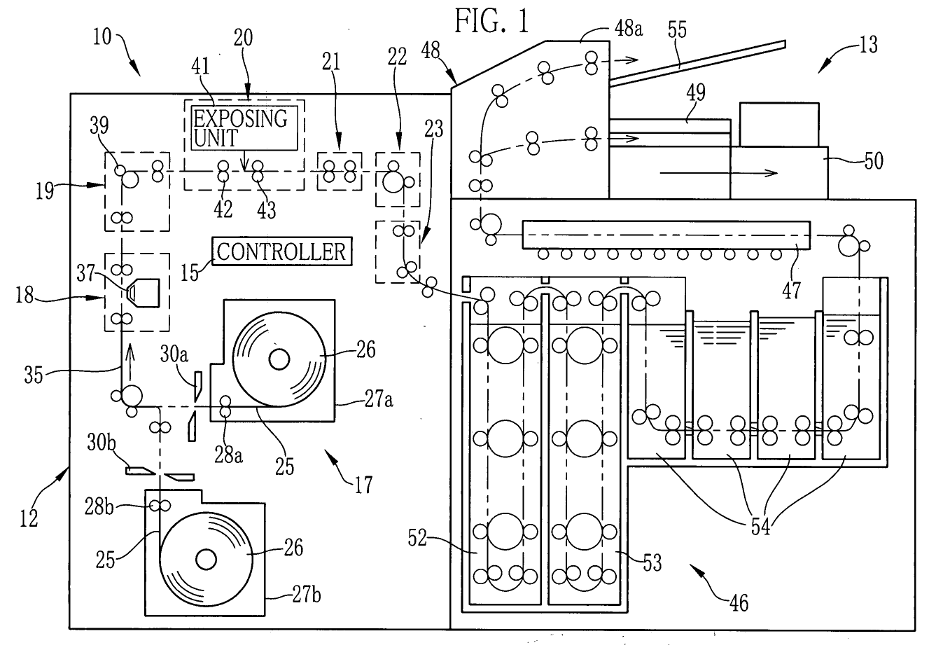

FIG. 1 is a schematic illustration showing a photographic printer (printer processor) 10 using a carrying device according to the present invention. As shown in FIG. 1, the photographic printer 10 is mainly constituted of a printer 12 and a processor 13. Each section of the photographic printer 10 is connected to a controller 15 via wiring, which is not shown, and the controller 15 controls the entire operation of the photographic printer 10.

The printer 12 records an image while feeding a recording material in a sub-scanning direction (feeding direction). The printer 12 is constituted of a supply section 17, a back-printing section 18, a skew-correcting section 19, an exposure section 20, a receiver section 21, a sorter section 22, a conveyor section 23 and so forth.

Magazines 27a and 27b are set in the supply section 17. Each of the magazines 27a and 27b contains a recording-paper roll 26 in which a photosensitive recording paper 25 is wound in a roll form. The respective magazines 27a and 27b are provided with paper roller pairs 28a and 28b for drawing out the recording paper 25 and carrying it toward the back-printing section 18. When the paper roller pairs 28a and 28b are rotated by a motor not shown, the recording papers 25 are drawn out of the recording-paper rolls 26 and are advanced toward cutters 30a and 30b.

The cutters 30a and 30b are respectively disposed so as to nip a passage of the recording paper 25. When an anterior end of the recording paper 25 is advanced from each of the cutters 30a and 30b by a predetermined length, a cutter driving mechanism not shown is actuated to cut the recording paper 25 into a paper sheet 35 of the predetermined length. Incidentally, instead of providing the two cutters, the sole cutter may be disposed near the back-printing section 18. The paper sheets 35 cut by the cutters 30a and 30b are carried by a plurality of carrying roller pairs disposed at the passages. The paper sheets 35 are carried along the passages, which are shown by double-dashed lines in the drawing, to pass through the back-printing section 18, the skew-correcting section 19, the exposure section 20, the receiver section 21, the sorter section 22 and the conveyor section 23 in this order.

The back-printing section 18 comprises a back-printing head 37 for recording print information on a rear surface of the paper sheet 35 (opposite surface to a recording surface). The print information includes a photographic date, a print date, a frame number, various IDs and so forth. As to the back-printing head 37, it is possible to use well-known print heads of a dot impact head, an ink jet head, a thermal transfer print head and so forth.

The skew-correcting section 19 is constituted of a resist roller pair 39 and the carrying roller pairs to prevent exposure position/angle from shifting relative to the exposure section 20. The resist roller pair 39 corrects a skew of the paper sheet 35, and the carrying roller pairs are disposed in front of and behind the resist roller pair 39. As to a method for correcting the skew with the resist roller pair 39, well-known methods may be used. For example, it is possible to adopt the methods described in Japanese Patent Laid-Open Publication Nos. 60-153358 and 11-349191.

The exposure section 20 is constituted of an exposing unit 41, feed roller pairs 42 and 43, and so forth. The exposing unit 41 comprises a laser printer and an image memory which are well known, although these are abbreviated in the drawing. The image memory stores image data, which is read out by a film scanner (not shown) or is outputted from a recording medium of a memory card (not shown) and so forth. The laser printer scans recording light (laser beam), whose intensity is modulated in accordance with the image to be recorded, in a scanning direction perpendicular to the sub-scanning direction to print the image on the paper sheet 35. Nip rollers of the feed roller pairs 42 and 43 are switchable between a position for nipping the paper sheet 35 and a position for separating therefrom. The nip roller is switched when a position sensor, which is not shown, detects an anterior end of the paper sheet 35 and a posterior end thereof. In virtue of this, it is possible to prevent a feed speed of the paper sheet 35 from fluctuating during the exposure.

The receiver section 21 comprises a plurality of roller pairs for retaining the anterior end of the paper sheet 35 forwarded from the exposure section 20 during the exposure. The receiver section 21 advances the paper sheet 35, at the same speed with a feed speed of the exposure section 20, to a downstream side in the carrying direction. Each roller pair of the receiver section 21 comprises a drive roller and a nip roller capable of releasing a nip. This roller pair does not nip the paper sheet 35 during the exposure recording. After the exposure recording has been completed for the posterior end, the nip roller is moved to nip the paper sheet 35 and to carry it to the sorter section 22.

The sorter section 22 sorts the paper sheets 35, which are carried in a single row, into plural rows while carrying them at a predetermined first speed. The paper sheets 35 are sorted in the scanning direction in accordance with sheet sizes. For instance, when the paper sheets 35 having a normal size and a small size are carried, the paper sheets are sorted into two rows. When the paper sheets having a large size are carried so as to be incapable of being carried in two rows, the paper sheets are carried in a single row as it is. The sorter section 22 is set as an exchangeable unit so that the sorter section having ability corresponding to a processing speed of the photographic printer 10 is removably set. Meanwhile, the conveyor section 23 conveys the paper sheet 35, which is forwarded from the sorter section 22, to the processor 13 at a second speed corresponding to a processing speed of the processor 13.

The processor 13 is constituted of a processing section 46, a drying section 47, a passage changing section 48, a rearranging section 49, a sorter 50 and so forth. The paper sheet 35 advanced from the printer 12 is carried in the processor 13 along a passage shown by a double-dashed line in the drawing. The processing section 46 includes a developing bath 52, a bleaching/fixing bath 53, and washing baths 54, which are disposed from an upstream side in this order. The developing bath 52 and the bleaching/fixing bath 53 respectively contain a developing solution and a bleaching/fixing solution by a predetermined amount. Further, the washing bath 54 contains washing water by a predetermined amount. While the paper sheet 35 is carried through the respective baths 52 to 54, the respective processes of developing, fixing and washing are executed for the paper sheet 35.

The drying section 47 is disposed above the respective baths 52 to 54 and is constituted of a conveyor belt and a blower duct not shown. The blower duct jets dry air, which is heated by a heater (not shown), toward the paper sheet 35 carried on the conveyor belt. In virtue of this, the washing water existing on the paper sheet 35 is removed. The dried paper sheet (photo print) 35 is forwarded to the passage changing section 48 disposed above an outlet of the drying section 47.

In the passage changing section 48, the paper sheets 35 having the normal size and carried in two rows are advanced toward the rearranging section 49. When the paper sheets 35 having the large size are carried in a single row, the passage is changed to advance the paper sheets 35 of the large size toward a tray 55 attached to a body 48a of the changing section. The passage changing section 48 applies the carrying device according to the present invention. Although the passage changing section 48 is described later in detail, this section 48 comprises two curved passages. In the rearranging section 49, the paper sheets 35 carried in two rows are rearranged so as to be carried in a single row. The rearranging section 49 is set in an exchangeable manner. The set rearranging section 49 has rearranging ability corresponding to processing ability of the photographic printer 10 (for example, the rearranging section 49 has a high rearrangement speed or has no rearranging function). The sorter 50 outputs the paper sheets 35, which are forwarded from the rearranging section 49, in a lump every print job.

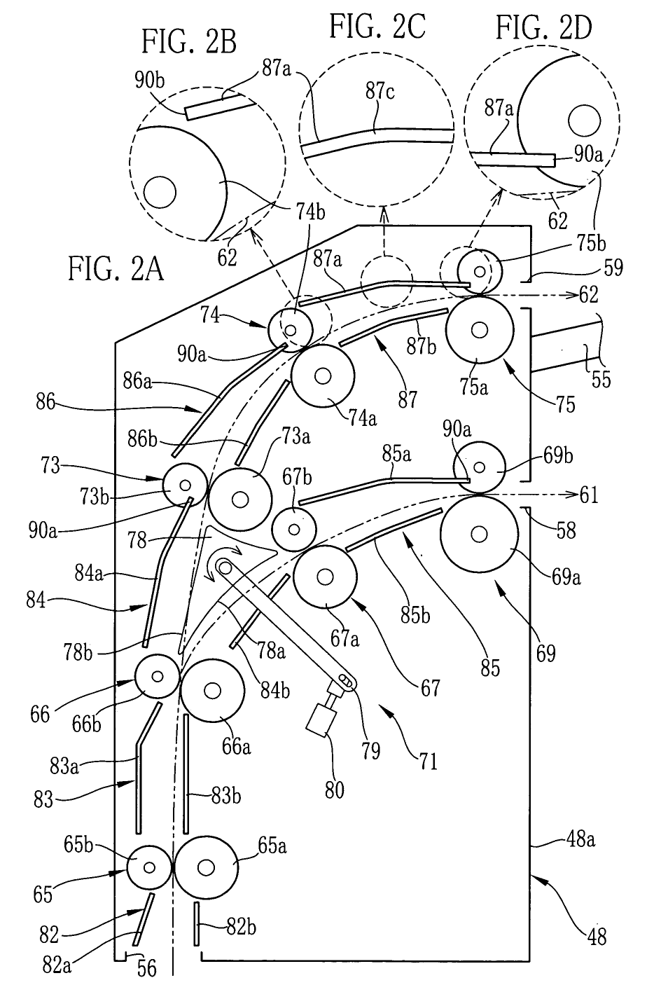

Next, the passage changing section 48 is described below with FIG. 2. Such as shown in FIG. 2, the bottom of the body 48a of the passage changing section 48 is formed with an inlet 56 for receiving the paper sheet 35 forwarded from the drying section 47. Moreover, a right side of the body 48a in the drawing is formed with a first outlet 58 for advancing the paper sheets 35, which are carried in two rows and have the normal size, toward the rearranging section 49. Further, a second outlet 59 for advancing the paper sheet 35 of the large size toward the tray 55 is formed above the first outlet 58. The inside of the body 48a is provided with a first passage 61 for carrying the paper sheet 35 of the normal size from the inlet 56 to the first outlet 58. From a halfway portion of the first passage 61, a second passage 62 branches. The paper sheet 35 of the large size is carried along the second passage 62 to the second outlet 59.

With respect to the first passage 61, first to third carrying roller pairs 65 to 67 and a high-speed discharge roller pair 69 are disposed between the inlet 56 and the first outlet 58 in order from the upstream side. The first passage 61 vertically and upwardly extends from the inlet 56 and is curved so as to horizontally extend near the first outlet 58. The respective roller pairs 65 to 67 and 69 are arranged along the curved first passage 61. Meanwhile, a guide changer 71 is disposed between the second and third carrying roller pairs 66 and 67 to change the passage in accordance with the size of the paper sheet 35.

The first to third carrying roller pairs 65 to 67 respectively comprise first to third capstan rollers 65a to 67a and first to third nip rollers 65b to 67b. The capstan roller is rotated by a motor not shown, and the nip roller is a driven roller. The respective capstan rollers 65a to 67a and the respective nip rollers 65b to 67b are disposed so as to nip the first passage 61. In this embodiment, a belt not shown is laid among the first to third capstan rollers 65a to 67a to rotate them at an identical peripheral velocity. Meanwhile, the high-speed discharge roller pair 69 comprises a high-speed driving roller 69a and a high-speed nip roller 69b. The high-speed driving roller 69a is adapted to be rotatable at a higher speed than the first to third capstan rollers 65a to 67a so that it is possible to shorten a time to be taken for discharging the paper sheet 35 to the rearranging section 49. At this time, the high-speed driving roller 69a is rotated at the same speed with the first to third capstan rollers 65a to 67a until the posterior end of the paper sheet 35 is advanced from the third carrying roller pair 67. Alternatively, the third carrying roller pair 67 may be adapted to be a free roller at the moment that the paper sheet has nipped by the high-speed discharge roller pair 69.

As described above, the second passage 62 branches from the guide changer 71, which is disposed at the halfway portion of the first passage 61, toward the second outlet 59. Fourth to sixth carrying roller pairs 73 to 75 are disposed between the guide changer 71 and the second outlet 59. The second passage 62 is also curved so as to horizontally extend near the second outlet 59, similarly to the first passage 61. The fourth to sixth carrying roller pairs 73 to 75 are disposed so as to be arranged along the curved second passage 62. The fourth to sixth carrying roller pairs 73 to 75 are basically identical with the first to third carrying roller pairs 65 to 67, and are respectively constituted of fourth to sixth capstan rollers 73a to 75a and fourth to sixth nip rollers 73b to 75b, which are disposed so as to nip the second passage 62.

The guide changer 71 is constituted of a changing guide 78, an arm member 79 and a solenoid 80, for example. One end of the arm member 79 is fixed to the changing guide 78, and the other end thereof is connected to the solenoid 80. The changing guide 78 is made of a plastic material and is formed with a first guide surface 78a and a second guide surface 78b. The first guide surface 78a steers the paper sheet 35 to the first passage 61, and the second guide surface 78b steers the paper sheet 35 to the second passage 62. Drive of the solenoid 80 is controlled by the above-described controller 15 (see FIG. 1). The controller 15 drives the solenoid 80 in accordance with the size of the paper sheet 35 to rotate the changing guide 78. In virtue of this, the first and second passages 61 and 62 are switched to carry the paper sheet 35. Incidentally, it is preferable that a sensor or the like is disposed at an upstream side of the changing guide 78 in the carrying direction to detect the size of the carried paper sheet 35.

First to sixth carrying guides 82 to 87 are respectively disposed at positions situated among the inlet 56, the first to third carrying roller pairs 65 to 67, the high-speed discharge roller pair 69, and the fourth to sixth carrying roller pairs 73 to 75. The respective carrying guides 82 to 87 guide the anterior end of the paper sheet 35, which is advanced from the upstream side, to the downstream carrying roller pair. The first to sixth carrying guides 82 to 87 may be made of a metal and a plastic. In this embodiment, however, the carrying guides are made of SUS (stainless steel) material on the grounds that this material is easily processed and hardly rusts out. The carrying guides 82 to 87 respectively comprise first to sixth recording-surface guides 82a to 87a disposed at a recording-surface side of the paper sheet 35, and first to sixth rear-surface guides 82b to 87b disposed at a rear-surface side of the paper sheet 35. Incidentally, the third recording-surface guide 84a and the third rear-surface guide 84b are disposed at both sides of the changing guide 78.

The first passage 61 is defined by the first to forth carrying guides 82 to 85 and the changing guide 78. The second passage 62 is defined by the third, fifth and sixth carrying guides 84, 86, 87 and the changing guide 78. In this embodiment, the passages are curved at four positions situated between the third carrying roller pair 67 and the high-speed discharge roller 69, between the second and fourth carrying roller pairs 66 and 73, between the fourth and fifth carrying roller pairs 73 and 74, and between the fifth and sixth carrying roller pairs 74 and 75. Thus, when the paper sheet 35 is carried along the third to sixth carrying guides 84 to 87 disposed between the respective roller pairs, the recording surface (emulsion surface) of the paper sheet 35 is likely to be damaged since the recording surface comes into contact with the third to sixth recording-surface guides 84a to 87a. In particular, when the paper sheet 35 is kept in the form of the recording-paper roll 26 (see FIG. 1) before printing such as described in the above, the recording surface is more likely to come into contact with the third to sixth recording paper guides 84a to 87a since the paper sheet 35 has a curling tendency of the roll.

In view of this, in the present embodiment, the arrangement and the shapes of the third to sixth recording-surface guides 84a to 87a are adjusted so as to prevent the recording surface of the paper sheet 35 from being damaged. Hereinafter, the shape and the arrangement of the sixth recording-surface guide 87a are described as an example.

With respect to the sixth recording-surface guide 87a, a guide end 90a of a downstream side thereof is disposed at a position being nearer to the second passage 62 in comparison with a central axis of the sixth nip roller 75b. In addition, the other guide end 90b of the upstream side is disposed at a position being farther from the second passage 62 in comparison with a central axis of the fifth nip roller 74b. In other words, the sixth recording-surface guide 87a is disposed so as to approach the second passage 62 as this guide 87a extends from the upstream fifth nip roller 74b to the downstream sixth nip roller 75b. By slantingly disposing the sixth recording-surface guide 87a relative to the second passage 62, the anterior end of the paper sheet 35 advanced from the fifth carrying roller pair 74 abuts on the sixth recording-surface guide 87a first. And then, the anterior end of the paper sheet 35 is guided to the sixth carrying roller pair 75, sliding on the sixth recording-surface guide 87a. Similarly, when the posterior end of the paper sheet 35 is advanced from the fifth carrying roller pair 74, this posterior end slides on the sixth recording-surface guide 87a and is guided to the sixth carrying roller pair 75.

Further, in order to prevent the recording surface of the paper sheet 35 from coming into contact with the sixth recording-surface guide 87a when the anterior end and the posterior end of the paper sheet 35 are guided to the sixth carrying roller pair 75, the sixth recording-surface guide 87a is curved in a V-like shape such that a surface thereof confronting the recording surface becomes concave. In addition, a curved portion 87c of the sixth recording-surface guide 87a has an R-shape to prevent the anterior end and the posterior end of the paper sheet 35 from being caught. As to a method for forming such a shape, there are a pressing method and a drawing method, for example. Incidentally, the whole of the sixth recording-surface guide 87a may be formed in an R-shape. However, it is preferable that the recording-surface guide 87a partially has the R-shape in consideration of processing accuracy and cost. The recording-surface guide 87a is slantingly disposed relative to the second passage 62 and the shape thereof is curved in the V-like shape. In virtue of this, only the anterior end and the posterior end of the paper sheet 35 come into contact with the sixth recording-surface guide 87a. Thus, the recording surface is prevented from sliding on the recording-surface guide 87a.

Since the sixth recording-surface guide 87a is disposed and has the shape such as described in the above, the recording surface of the paper sheet 35 is appreciably prevented from coming into contact with the sixth recording-surface guide 87a. However, when the guide end 90a is straightly formed in the width direction (scanning direction) of the paper sheet 35, a gap is caused between the guide end 90a and the sixth nip roller 75b. As a result, the recording surface of the paper sheet 35 is likely to come into contact with an edge of the guide end 90a.

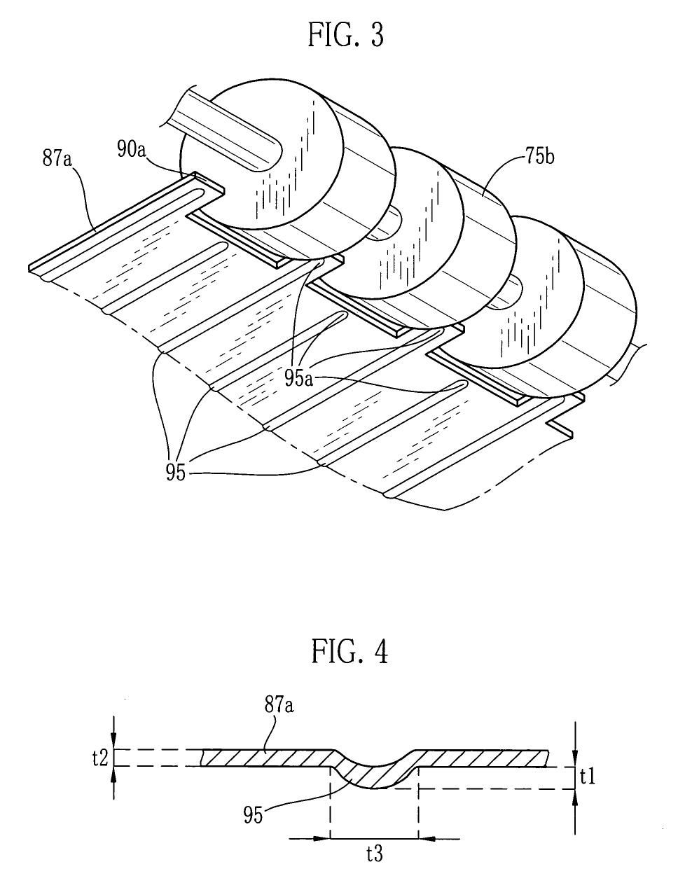

In consideration of this, the sixth nip roller 75b is adapted to be a skewered-type roller, such as shown in FIG. 3. Additionally, the guide end 90a of the sixth recording-surface guide 87a is formed in a comb-like shape in accordance with the shape of the sixth nip roller 75b having the skewered type. Arrangement of the sixth recording-surface guide 87a and the sixth nip roller 75b is adjusted such that a convex portion of the guide end 90a formed in the comb-like shape is inserted into a roller gap of the sixth nip roller 75a of the skewered type.

The surface of the sixth recording-surface guide 87a confronting the paper sheet 35 is formed with a plurality of ribs 95, which are parallel in the carrying direction of the paper sheet 35 and are arranged in the width direction thereof. It is preferable that at least one rib 95 is formed on each of the convex portions of the guide end 90a. Meanwhile, if the respective ribs 95 are formed so as to extend over the edge of the guide end 90a, this edge might have a wave shape. In this case, when the paper sheet 35 is carried, the recording surface thereof is likely to be damaged due to the contact with the edge of the wave shape. For the purpose of preventing this, in the present embodiment, a downstream rib end 95a of each rib 95 is formed at an upstream side of the edge of the guide end 90a. At the same time, the rib end 95a is formed in an R-shape.

In general, the rib 95 is formed by drawing. Thus, if the rib is overly heightened, draw wrinkles occur on the top of the rib 95 so that the recording surface is likely to be easily damaged. Further, processing and time become necessary for buffing the rib 95. In consideration of this, the rib 95 is formed such that tallness t1 thereof is set within a range of 0.2 to 0.4 mm. Incidentally, in the present embodiment, a thickness t2 of the sixth recording-surface guide 87a is set within a range of 0.8 to 11.0 mm, and a width t3 of the rib 95 is about 6.0 mm. Moreover, a rolling direction of material is parallel with the rib 95. In virtue of these conditions, the draw wrinkles are prevented from occurring and it is possible to shorten the processing and the time to be required for buffing.

Since the convex portion of the comb-shaped guide end 90a enters the roller gap of the sixth nip roller 75b of the skewered shape, the convex portion is prevented from coming into contact with the paper sheet 35. Moreover, a concave portion of the guide end 90a is also prevented from coming into contact with the recording surface of the paper sheet 35, since the rib 95 is formed on the respective convex portions of the guide end 90a. Consequently, the recording surface of the paper sheet 35 does not come into contact with the guide end 90a so that the recording surface is prevented from being damaged.

Such as shown in FIG. 2, the third to fifth recording-surface guides 84a to 86a are slantingly disposed relative to the passages 61 and 62, similarly to the sixth recording-surface guide 87a. In addition, these guides 84a to 86a are curved in a V-like shape. Meanwhile, slanting angles of the guides 84a to 87a and curving angles thereof are adjusted to optimum angles in accordance with the shapes of the passages 61 and 62, features (thickness and stiffness) of the paper sheet 35, etc. so as not to come into contact with the recording surface of the paper sheet 35.

Further, the nip rollers 69b, 73b and 74b disposed at the downstream sides of the third to fifth recording-surface guides 84a to 86a also have a skewered shape. Additionally, guide ends 90a of the recording-surface guides 84a to 86a are also formed in a comb-like shape. Convex portions of the respective guide ends 90a formed in the com-like shape are inserted into roller gaps of the respective nip rollers 69b, 73b and 74b of the skewered shape. Although illustration is omitted in FIG. 2, the third to fifth recording-surface guides 84a to 86a are also formed with the ribs 95 similarly to the sixth recording-surface guide 87a.

Next, an operation of the photographic printer 10 having the above structure is described below with FIGS. 1, 2, 5 and 6. Upon a print instruction of a user, the controller 15 draws the photosensitive recording papers 25, by the predetermined length, from the magazines 27a and 27b disposed in the supply section 17, such as shown in FIG. 1. And then, the cutters 30a and 30b are actuated to produce the paper sheets 35. After the predetermined information of the photographic information and so forth has been recorded in the back-printing section 18, the skew of the paper sheet 35 is corrected in the skew-correcting section 19. The paper sheet 35 having passed through the skew-correcting section 19 is forwarded to the exposure section 20 wherein scanning exposure of an image is performed by the laser beam modulated on the basis of the image data.

The paper sheet 35 for which the image has been recorded passes through the receiver section 21 and is sent to the sorter section 22. When the paper sheets 35 having the normal size or the small size are carried, the paper sheets 35 are sorted into two rows in the sorter section 22. When the paper sheets 35 have the large size, the paper sheets 35 are carried in a single row as it is, since it is impossible to carry them in two rows. The present embodiment is described under the condition that the paper sheet 35 has the normal size. The paper sheets 35 sorted into two rows pass through the conveyor section 23 and are forwarded to the processor 13.

The paper sheet 35 forwarded to the processor 13 is developed, fixed and washed in the developing bath 52, the bleaching/fixing bath 53 and the washing bath 54. After that, the paper sheet 35 is forwarded to the drying section 47 wherein the dry air heated by the heater is jetted toward the paper sheet 35 to remove the washing water existing thereon. The dried paper sheet 35 is forwarded to the passage changing section 48 disposed above the exit of the drying section 47.

As shown in FIG. 2, the paper sheet 35 forwarded to the passage changing section 48 is carried from the inlet 56 into the body 48a of the changing section. At this time, the controller 15 activates the solenoid 80 to rotate the changing guide 78 in the clockwise direction so that the paper sheets 35 having the normal size and carried in two rows are advanced toward the first outlet 58 along the first passage 61. The paper sheet 35 carried into the body 48a passes through the first to third carrying roller pairs 65 to 67 in order along the first carrying guide 82, the second carrying guide 83 and the changing guide 78.

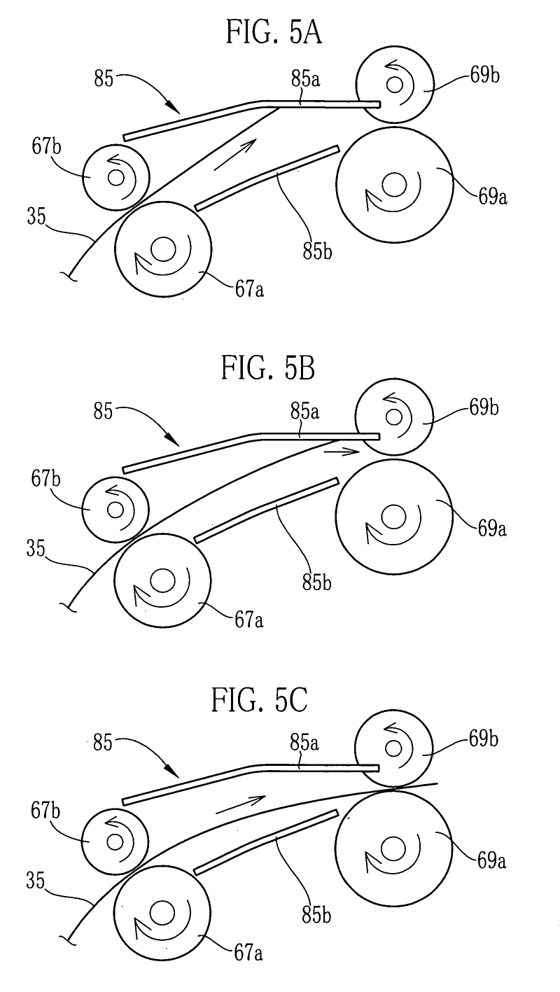

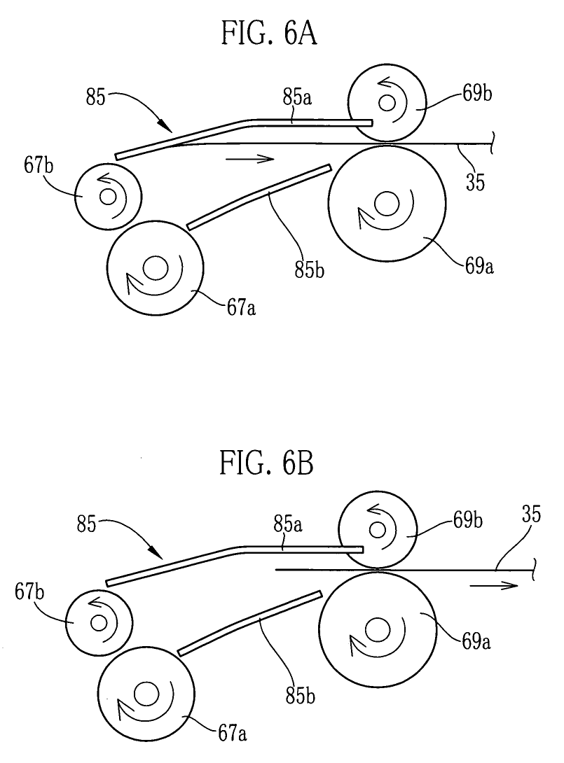

As shown in FIG. 5A, the anterior end of the paper sheet 35 advanced from the third carrying roller pair 67 abuts on the fourth recording-surface guide 85a first. Incidentally, FIGS. 5B, 5C, 6A and 6B, which are described later, and FIG. 5A are explanatory illustrations for explaining the states of the paper sheet 35 passing through the third carrying roller pair 67 and the high-speed discharge roller pair 69. The paper sheet 35 of one row is merely illustrated in FIGS. 5 and 6. However, the other row is similarly carried, although illustration thereof is omitted.

The paper sheet 35 is successively advanced by the third carrying roller pair 67 after the anterior end of the paper sheet 35 has abutted on the fourth recording-surface guide 85a. Since this guide 85a is slantingly disposed relative to the first passage 61 and the shape thereof is curved in the V-like shape, the anterior end of the paper sheet 35 slides on the fourth recoding-surface guide 85a and is guided to the high-speed discharge roller pair 69 (see FIG. 5B). At this time, only the anterior end of the paper sheet 35 abuts on the fourth recoding-surface guide 85a so that the recording surface of the paper sheet 35 is prevented from being damaged. Moreover, the guide end 90a of the fourth recording-surface guide 85a is formed in the comb-like shape, and the guide end 90a of the comb-like shape is inserted into the roller gap of the high-speed nip roller 69b of the skewered shape. Further, the surface of the guide 85a confronting the paper sheet 35 is formed with the ribs 95 (see FIG. 3). Thus, it is possible to prevent the recording surface from being damaged by the edge of the guide end 90a. The anterior end of the paper sheet 35 guided to the high-speed discharge roller pair 69 is nipped thereby, and then, this paper sheet 35 is further advanced (see FIG. 5C) toward the first outlet 58 (see FIG. 2).

Successively, carrying the paper sheet 35 is continued. As shown in FIG. 6A, when the posterior end of the paper sheet 35 has been advanced from the third carrying roller pair 67, only this posterior end abuts on the fourth recording-surface guide 85a. After the posterior end of the paper sheet 35 has left the third carrying roller pair 67, the high-speed discharge roller 69 is rotated at the high speed to discharge the paper sheet 35 from the first outlet 58. At this time, the posterior end of the paper sheet 35 slides on the fourth recording-surface guide 85a and is guided to the high-speed discharge roller pair 69 (see FIG. 6B). Only the posterior end of the paper sheet 35 comes into with the fourth recording-surface guide 85a and the guide end 90a thereof so that the recording surface of the paper sheet 35 is prevented from being damaged.

When the paper sheet 35 is carried along the fourth carrying guide 85, only the anterior end and the posterior end come into contact with the fourth recording-surface guide 85a, and the recording surface of the paper sheet 35 does not come into contact with the guide 85a. Thus, the recording surface of the paper sheet 35 is prevented from being damaged. Meanwhile, when the paper sheet 35 having the large size is carried along the third, fifth and sixth recording-surface guides 84a, 86a and 87a of the second passage 62, as shown in FIG. 2, the recording surface of the paper sheet 35 is similarly prevented from being damaged.

As shown in FIG. 1, the paper sheets 35 discharged from the first outlet 58 in two rows are rearranged in a single row at the rearranging section 49, and are forwarded to the sorter 50. The paper sheets 35 are gathered every print job in the sorter 50, and then, the paper sheets 35 are discharged to the outside of the photographic printer 10.

The present invention is not limited to the inside of the passage changing section 48. It is possible to adopt the present invention to the other carrying guides (recording-surface guides) disposed at passages of the photographic printer 10 where the recording surface of the paper sheet 35 is curved so as to be convex. For example, in FIG. 1, there is a passage for carrying the paper sheet 35, which has been dried in the drying section 47, toward the passage changing section 48 disposed above. At this passage, the recording surface is curved so as to be convex. Thus, in a case that carrying guides for guiding the paper sheet 35 from the drying section 47 to the passage changing section 48 are provided, these carrying guides may be similarly disposed and may have similar shapes with the above-described third to sixth recording-surface guides 84a to 87a.

Further, the present invention is not exclusive to the photographic printer, but may be adopted to various printers in which passages for carrying the recording material are curved. For instance, it is possible to adopt the present invention to thermal printer, a thermal-transfer printer, an ink-jet printer, an electrophotographic printer and so forth. It is also possible to adopt the present invention to a photographic printer of a type that an image is directly recorded by projection light radiated from a film.

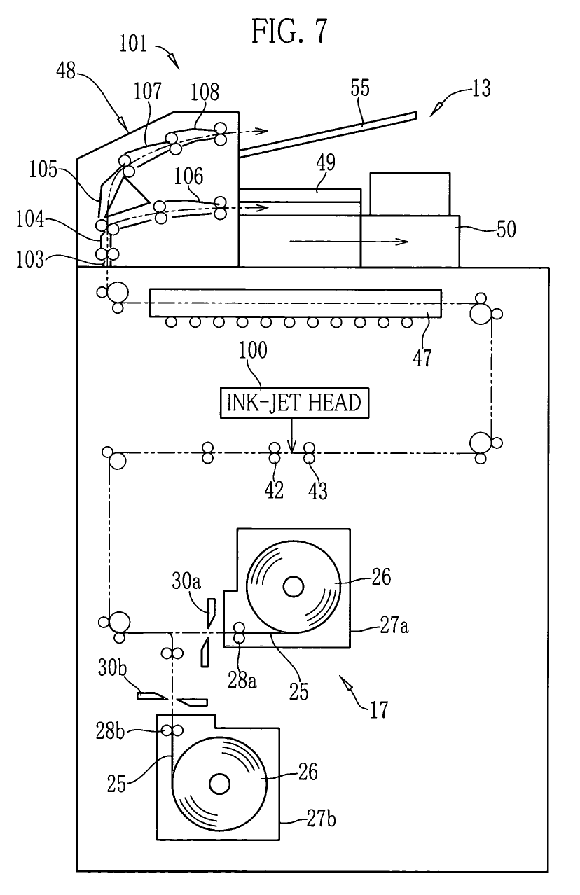

Another embodiment shown in FIG. 7 is described below. In this embodiment, the present invention is adopted to an ink-jet printer 101 comprising an ink-jet head 100 instead of the exposure section 20 and the processing section 46 (see FIG. 1). Incidentally, FIG. 7 shows a schematic illustration of the ink-jet printer 101. In this drawing, a member being identical with that of the photographic printer 10 is denoted by the same reference numeral and description thereof is abbreviated.

Similarly to the photographic printer 10, the passage changing section 48 is disposed above the outlet of the drying section 47 in the ink-jet printer 101. The passages of the passage changing section 48 are curved so as to make the recording surface of the paper sheet 35 convex. Thus, the recording surface of the paper sheet 35 is likely to be damaged in case the recording surface comes into contact with first to sixth carrying guides 103 to 108, particularly with the third to sixth carrying guides 105 to 108.

In view of this, the third to sixth carrying guides 105 to 108 are similarly arranged and have similar shapes with the third to sixth carrying guides 84 to 87 (see FIG. 2) of the photographic printer 10. In virtue of this, it is possible to prevent the recording surface of the recording sheet 35 from being damaged by coming into contact with the third to sixth carrying guides 105 to 108. Meanwhile, although the ink-jet printer 101 is provided with the drying section 47, the present invention is not limited to this. The drying section 47 may be removed. Also in this case, the recording surface of the paper sheet 35 is prevented from coming into contact with the third to sixth carrying guides 105 to 108 so that the recording surface is hardly damaged.

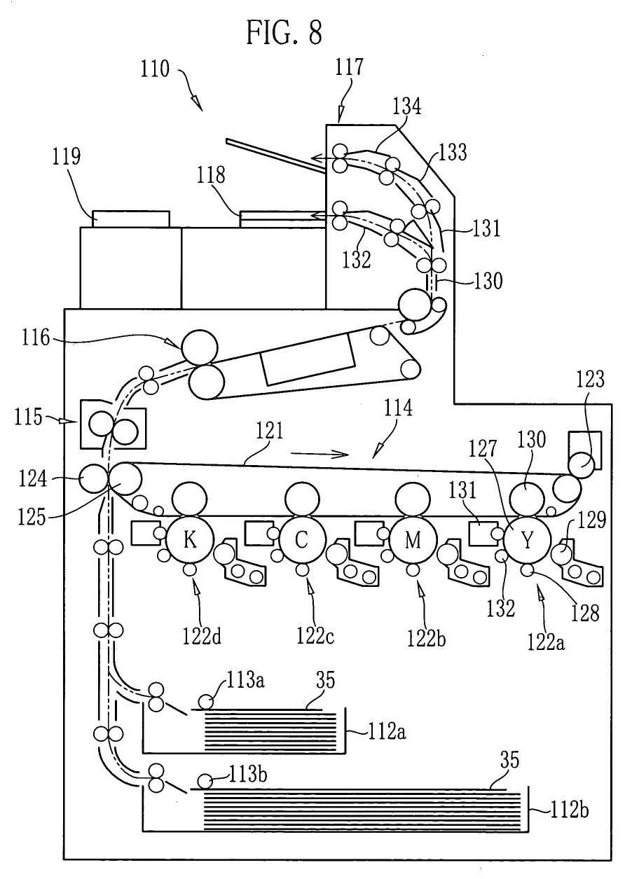

Next, an electrophotographic printer 110 shown in FIG. 8 and to which the present invention is applied is described below. The electrophotographic printer 110 includes paper trays 112a and 112b containing the different-sized paper sheets 35, pickup rolls 113a and 113b, an image-transferring section 114, a first fixing section 115, a second fixing section 116, a passage changing section 117 to which the present invention is applied, are arranging section 118, a sorter 119, carrying roller pairs and carrying guides. The carrying roller pairs and the carrying guides are disposed along passages (shown by double-dashed lines in the drawing) of the paper sheet 35.

The image transferring section 114 is constituted of an endless intermediate image transfer belt 121, electrophotographic image forming units 122a, 122b, 122c and 122d, a belt cleaner 123, a secondary image transfer roll 124, and a backup roll 125. The intermediate image transfer belt 121 is stretched between stretch rolls and is circulated. The electrophotographic image forming units 122a to 122d are aligned in a circulating direction of the intermediate image transfer belt 121 to form toner images of yellow, magenta, cyan and black. The belt cleaner 123 and the secondary image transfer roll 124 confront the intermediate image transfer belt 121. Incidentally, the electrophotographic image forming units 122a to 122d are respectively constituted of a photoreceptor drum 127, a charging roll 128, a processor 129, a first image transfer roll 130, a drum cleaner 131, and a discharging roll 132.

At the time of printing, electrostatic latent images corresponding to a yellow image, a magenta image, a cyan image and a black image are formed on surfaces of the respective photoreceptor drums 127. The respective latent images become the toner images at the processors 129. The toner images are transferred in order to the intermediate image transfer belt 121 by pressing force of the respective first image transfer rolls 130 to form a full-color toner image. Meanwhile, the paper sheet 35 is advanced from one of the paper trays 112a and 112b at predetermined timing and is carried to a gap formed between the secondary image transfer roll 124 and the backup roll 125. And then, the full-color toner image formed on the intermediate image transfer belt 121 is transferred to the recording surface of the paper sheet 35 by pressing force of the secondary image transfer roll 124.

The paper sheet 35 to which the full-color toner image has been transferred is carried to the first fixing section 115 where first fixation is performed for the toner image of the paper sheet 35 by means of heating and pressing. Successively, the paper sheet 35 is carried to the second fixing section 116 where second fixation is performed for the toner image of the paper sheet 35, for which the first fixation has been performed, by means of heating and pressing. After that, the paper sheet 35 is carried to the passage changing section 117 disposed above the second fixing section 116.

Also in the passage changing section 117, the passages are curved so as to make the recording surface of the paper sheet 35 convex. Thus, the recording surface of the fixed paper sheet 35 is likely to be damaged. In view of this, the second to fifth carrying guides 131 to 134 of the passage changing section 117 are adapted to have similar arrangement and similar shapes with the third to sixth carrying guides 84 to 87 of the photographic printer 10 (see FIG. 2). In virtue of this, it is possible to prevent the recording surface of the paper sheet 35 from coming into contact with the second to fifth carrying guides 131 to 134. Consequently, the recording surface of the paper sheet 35 is hardly damaged similarly to the photographic printer 10 and the ink-jet printer 101.

As described above, by employing the carrying device (passage changing section) according to the present invention, only the anterior end and the posterior end of the paper sheet 35 come into contact with the carrying guides and the recording surface of the paper sheet is prevented from coming into contact therewith. Thus, it is possible to prevent the recording surface of the paper sheet 35 from being damaged in various printers of the photographic printer 10, the ink-jet printer 101, the electrophotographic printer 110 and so forth.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A recording-material carrying device for carrying a recording material along a curved passage, comprising:
a plurality of carrying roller pairs disposed along said curved passage, said carrying roller pair including a recording-surface side roller for coming into contact with a recording-surface side of said recording material, and a rear-surface side roller for coming into contact with a rear-surface side of said recording material; and
a carrying guide disposed between the adjacent two carrying roller pairs to guide a recording surface of said recording material toward the downstream carrying roller pair in a carrying direction of said recording material, said carrying guide having a first guide end of a downstream side and a second guide end of an upstream side,
wherein said first guide end is situated at a closer position to said passage relative to a central axis of said recording-surface side roller, and said second guide end is situated at a farther position from said passage relative to the central axis of said recording-surface side roller.

2. A recording-material carrying device according to claim 1, wherein said carrying guide is curved in a V-shape such that a side thereof confronting said recording surface of said recording material is concave.

3. A recording-material carrying device according to claim 2, wherein a curved portion of said carrying guide curved in the V-shape is formed in an arc shape.

4. A recording-material carrying device according to claim 3, wherein a curvature angle of said curved portion is determined in accordance with a thickness and stiffness of said recording material.

5. A recording-material carrying device according to claim 1, wherein said recording-surface side roller is a skewered-shape roller and at least said first guide end is formed in a comb-shape corresponding to said skewered-shape roller, said carrying guide being disposed so as to insert said first guide end of said comb-shape into roller gaps of said skewered-shape roller.

6. A recording-material carrying device according to claim 1, wherein a surface of said carrying guide confronting said recording surface of said recording material is formed with a plurality of ribs, which extend in parallel to the carrying direction of said recording material and are arranged in a width direction of said recording material.

7. A recording-material carrying device according to claim 6, wherein a downstream end of said rib in the carrying direction extends close to said first guide end and is formed in an arc shape.

8. A recording-material carrying device according to claim 6, wherein a height of said rib is set within a range of 0.2 to 0.4 mm.

9. A recording-material carrying device according to claim 7, wherein said first guide end has a comb-shape comprising a convex portion and a concave portion, and said convex portion is formed with at least one rib.

10. A photographic printer comprising an exposing device for performing image exposure on a recording material, a processing device for processing the exposed recording material, a drying device for drying the processed recording material, and a recording-material carrying device disposed at a downstream side of said drying device in a carrying direction of said recording material, said recording-material carrying device carrying said recording material along a curved passage and comprising:
a plurality of carrying roller pairs disposed along said curved passage, said carrying roller pair including a recording-surface side roller for coming into contact with a recording-surface side of said recording material, and a rear-surface side roller for coming into contact with a rear-surface side of said recording material; and
a carrying guide disposed between the adjacent two carrying roller pairs to guide a recording surface of said recording material toward the downstream carrying roller pair in a carrying direction of said recording material, said carrying guide having a first guide end of a downstream side and a second guide end of an upstream side,
wherein said first guide end is situated at a closer position to said passage relative to a central axis of said recording-surface side roller, and said second guide end is situated at a farther position from said passage relative to the central axis of said recording-surface side roller.

11. An ink-jet printer comprising an ink-jet head for recording an image by jetting an ink toward a recording material, and a recording-material carrying device disposed at a downstream side of said ink-jet head in a carrying direction of said recording material, said recording-material carrying device carrying said recording material along a curved passage and comprising:
a plurality of carrying roller pairs disposed along said curved passage, said carrying roller pair including a recording-surface side roller for coming into contact with a recording-surface side of said recording material, and a rear-surface side roller for coming into contact with a rear-surface side of said recording material; and
a carrying guide disposed between the adjacent two carrying roller pairs to guide a recording surface of said recording material toward the downstream carrying roller pair in a carrying direction of said recording material, said carrying guide having a first guide end of a downstream side and a second guide end of an upstream side,
wherein said first guide end is situated at a closer position to said passage relative to a central axis of said recording-surface side roller, and said second guide end is situated at a farther position from said passage relative to the central axis of said recording-surface side roller.

12. An electrophotographic printer comprising an image-transferring unit for transferring a toner image, which is formed in an electrophotographic manner, to a recording material, and a recording-material carrying device disposed at a downstream side of said image-transferring unit in a carrying direction of said recording material, said recording-material carrying device carrying said recording material along a curved passage and comprising:
a plurality of carrying roller pairs disposed along said curved passage, said carrying roller pair including a recording-surface side roller for coming into contact with a recording-surface side of said recording material, and a rear-surface side roller for coming into contact with a rear-surface side of said recording material; and
a carrying guide disposed between the adjacent two carrying roller pairs to guide a recording surface of said recording material toward the downstream carrying roller pair in a carrying direction of said recording material, said carrying guide having a first guide end of a downstream side and a second guide end of an upstream side,
wherein said first guide end is situated at a closer position to said passage relative to a central axis of said recording-surface side roller, and said second guide end is situated at a farther position from said passage relative to the central axis of said recording-surface side roller.
